(19) United States
(12) Patent Application Publication
(10) Pub. No.: US 2011/0102688 A1
(43) Pub. Date: May 5, 2011

(54) REAR PROJECTION SYSTEM AND REAR PROJECTION SCREEN

(75) Inventor: Dirk Kornelis Gerhardus De Boer, Den Bosch (NL)

(73) Assignee: KONINKLIJKE PHILIPS ELECTRONICS N V, Eindhoven (NL)

(21) Appl. No.: 12/994,890

(22) PCT Filed: Jun. 4, 2009
(86) PCT No.: PCT/IB2009/052358

§ 371 Date: Nov. 29, 2010

(30) Foreign Application Priority Data
Jun. 11, 2008 (EP) 08104359.8

(51) Int. Cl. G02F 1/1335; G03B 21/62; H01R 43/00

(52) U.S. Cl. 349/5; 359/460; 353/20; 29/825

(57) ABSTRACT

To provide a rear projection system, which offers a high transparency and a high efficiency of projection, a rear projection system is proposed, comprising: a projector (18), and a projection screen (16) being switchable between a transparent mode and a diffractive mode, wherein the projector (18) is located with respect to the projection screen (16) such that light from the projector (18) is incident at an inclined angle at the rear side of the projection screen (16), the projection screen (16) is adapted to deflect in its diffractive mode the incident light into a limited angle range with respect to the front surface normal of the screen (16).

### FIELD OF THE INVENTION

The invention relates to a rear projection system and a rear projection screen, in particular to a rear projection system for a shopping window.

### BACKGROUND OF THE INVENTION

Transparent projection screens offer a wide field for applications, wherein one of these applications is the usage of such a screen for interactive shop windows. Presently, so-called “holoscreens” are used to project information on the screen while allowing to see the objects behind it. The main problem of these screens is that they are not really transparent, hindering the visibility of the objects behind the shop window.

Such a holographic screen of a displaying system is described in U.S. Pat. No. 6,522,311 B1. Herein, a display unit includes a transparent support, a hologram screen attached to the transparent support, a projector for projecting an image information onto the hologram screen, and a sensor to determine, whether or not there is a person within an area in a viewing angle of the hologram screen. This displaying system is employed preferably for shopping windows. In addition, a controller is provided, which controls the projector in response to signals from the sensor such that, if the sensor detects a person within the area in the viewing angle of the hologram screen, in particular in front of the shopping window, the controller activates the projector to project the image information onto the hologram screen in the shopping window.

A further projection system is known from U.S. Pat. No. 6,191,876 B1 concerning a light diffusion control by electrically reconfigurable holographic optical elements. Herein, each reconfigurable holographic element includes a hologram that is sandwiched between two electrode layers. The hologram is a holographic polymeric film that has been combined with liquid crystal and which has an optical property that changes in response to an applied electrical field. The diffusing characteristic of the projection screen can be changed by selectively setting one or more reconfigurable holographic optical elements to a diffractive state. Herein, in one application, the screen is utilized to optimally diffuse the projected images with respect to light intensity, so that the projected images appear to be uniformly bright to multiple observers at different viewing regions. In another application, the screen is utilized to display the projected images in a stereoscopic form.

### OBJECT AND SUMMARY OF THE INVENTION

It is therefore an object of the present invention to provide a rear projection system and a rear projection screen offering a high transparency and a high efficiency of projection.

This object is solved by the features of the independent claims.

In particular, the present invention is based on the thought to provide a projection screen for a shopping window or the like, which could be switched between a transparent mode and a diffractive mode. Herein, the diffractive mode has to be understood as a state of the screen, in which the screen is acting like a diffuse hologram. Thus, light being incident from a certain angle at the rear surface of the screen is deflected and directly transmitted to an observing person in front of the screen. In the diffractive mode, the intensity of the displayed, i.e. deflected light can be as high as 10% or more of that of the incident beam of a projector. In a transparent mode, the screen acts as a transparent substrate like a normal glass or another comparable substrate. Thus, an object behind the projection screen preferably being employed as a shopping window or being mounted at a shopping window could be easily seen in a transparent mode of the screen, while in a diffractive mode an image containing an information of the object of interest could be projected from the projector to a rear side of the screen reaching the objecting person with high luminance.

Herein, the projector and the projection screen are located with respect to each other in such a way that the light beam from the projector is incident at a slanted angle at the rear side of the projection screen and then, in a diffractive mode, deflected mainly in a direction being parallel to the surface normal of the projection screen.

In summary, the rear projection system of the present invention comprises a projector, and a projection screen being switchable between a transparent mode and a diffractive mode, wherein the projector is located with respect to the projection screen such that light from the projector is incident at an inclined angle at the rear side of the projection screen, the projection screen is adapted to deflect in its diffractive mode, the incident light into a limited angular range with respect to the front surface normal of the screen.

This rear projection system of the present invention is preferably employed in a shopping window, wherein the screen could be used as a shopping window or being simply mounted to a shopping window. In a transparent mode, the object behind the shopping window could be easily watched, wherein in a diffractive mode of the screen an information about these objects or information in which a costumer is interested could be faded in.

It is preferred that the angle of incidence between the incident light of the projector and the rear surface normal of the screen is bigger than 30°, since in this preferred geometrical arrangement, the projector could be placed out of sight of a person watching at objects behind a shopping window.

Since in a diffractive mode, the diffusive portion of the deflected light is very low, the angular range of the emitted light from the screen to a front side with respect to the front surface normal of the screen is limited, and extends preferably from −10° to 10° in the vertical direction and at least from −30° to 30° in the horizontal direction.

For an application of a screen having a liquid crystal material it is preferred to use polarised light for the projector.

In a preferred embodiment of the rear projection system according to the present invention, the projection screen comprises a first transparent substrate with a first transparent electrode, a composition of a liquid crystal material and a compound material, and a second transparent substrate with a second electrode. Herein, the refractive index of the liquid crystal material, which is disposed between the first and the second substrate is switchable by means of an electrical field generated by the first and second electrode. Herein, the refractive indices of the liquid crystal material and the compound material are chosen in such a way that the refractive index for the polarised light from the projector of the liquid crystal material in presence of an electrical field is the same as the refractive index of the compound material and different in case of no electrical field being applied. However, it is also possible to choose the refractive index and orientation in such a way that the refractive index for the polarised light from the projector of the liquid crystal material in presence of an electrical field is different and in absence of an electrical field is equal to the refractive index of the compound material.

Preferably, the compound material is a polymer, which is surrounded by the liquid crystal material and which is polymerized in such a way that it forms a volume Bragg grating. The Bragg grating appears optically in case of different refractive indices of the liquid crystal material and the compound material, and is therefore switchable. Thus, the present invention has the advantage that the projection screen comprising the composition of a liquid crystal material and compound material forming a switchable Bragg grating could be easily switched between a diffractive mode and a transparent mode by simply applying an electrical field.

In one preferred embodiment, the composition of the liquid crystal material and the compound material is a holographic-dispersed liquid crystal (HPDLC) material. In further preferred embodiments of the present invention, the composition of the liquid crystal material and the compound material is a polymer liquid-crystal polymer slices (POLICRYPS) material or a polymer liquid-crystal polymer hologram electrically manageable (POLIPHEM) material. These further compositions forming Bragg gratings have the advantage that no droplets of liquid crystal material are built in the composition, thus scattering losses are strongly reduced, the switching voltage is much lower, and a time response in a microsecond range could be achieved. In addition, a higher refractive index modulation is achievable and a sharper resolution of the grating could be obtained.

In a still another embodiment of the present invention, the projection screen of the rear projection system according to the present invention comprises a composition being a photopolymerized mixture of monoacrylates, diacrylates and non-reactive liquid crystal material, which forms a liquid crystal gel being disposed between the first and second substrate.

In addition, the object of the present invention is solved alternatively by a rear projection screen being switchable between a transparent mode and a diffractive mode, wherein the projection screen comprises a first transparent substrate, a liquid crystal material disposed on the first transparent substrate and a second transparent substrate. The first transparent substrate comprises a first transparent electrode and a relief portion with a surface-relief grating. The liquid crystal material is located next to the relief portion of the first transparent substrate and filling the surface-relief grating. Herein, the refractive index of the liquid crystal material is changed by means of electrical field of a first and a second electrode being disposed on the first and the second transparent substrate, respectively, to be substantially equal to or unequal from the refractive index of the relief portion of the first transparent substrate. Thus, the surface-relief grating at the transition of the liquid crystal material to the relief portion of the first transparent substrate becomes visible or invisible in dependence on the applied electrical field, thus forming a switchable two-dimensional Bragg grating in the transition plane between the liquid crystal material and the relief portion of the first transparent substrate.

For instance, the first transparent substrate comprises a support layer of PMMA (polymethyl methacrylate) and a relief layer of polycarbonate forming the relief portion, which faces the liquid crystal layer.

In addition, the second substrate preferably comprises a support layer of glass or transparent polymer and a rubbed polyimid layer facing the liquid crystal layer to provide a predetermined orientation of the liquid crystal in the liquid crystal layer.

For an advantageous application of the rear projection screen according to the present invention in an optical range of visible light, it is preferred to manufacture the surface-relief grating with a grating period of about 1000 nm and a modulation depth of about 100-300 nm.

In addition, it is preferred to manufacture the surface-relief grating by an embossing process. Herein, preferably an embossing master is used, on which a first grating is formed using a setup as described in view of FIG. 2 for generating an interference pattern, which is then transferred to the embossing master by means of electroforming into nickel. This can be used as embossing tools for precision micro replication processes, such as injection moulding, hot embossing or continuous film replication.

The object of the present invention is further solved by a method for projecting an image, comprising the steps of providing a projector and a projection screen being switchable between a transparent mode and a diffractive mode, locating the projector with respect to the projection screen such that light from the projector is incident at an inclined angle at the rear side of the projection screen, and switching the projection screen from the transparent mode to a diffractive mode, when an image has to be displayed, wherein the incident light of the projector is deflected into a limited angular range with respect to the front surface normal of the projection screen.

This method of projecting an image is preferably used for a projection of an image in a shopping window.

In addition, it is preferred to employ in the method for projecting an image a switchable projection screen according to one of the described embodiments of the present invention.

### BRIEF DESCRIPTION OF THE DRAWINGS

The above and other objects, features and other advantages of the present invention will be more clearly understood from the following detailed description taking in conjunction with the accompanying drawings. The invention will now be described in greater detail hereinafter, by way of non-limiting examples, with reference to the embodiments shown in the drawings.

FIG. 1 is a schematical view illustrating the arrangement of the projector and the projection screen of the projection system according to the present invention;

FIG. 2 is a view illustrating a set-up for manufacturing the projection screen according to the present invention;

FIG. 3 is an embodiment of the projection screen according to the present invention;

FIG. 3a is a schematic view showing the diffraction of incoming light at a switchable Bragg grating in the projection screen of FIG. 3;

FIG. 4 is another embodiment of the projection screen according to the present invention, and

FIG. 4a is a schematic view showing the diffraction of incoming light at a relief-surface grating as in the projection screen of FIG. 4.

### DESCRIPTION OF EMBODIMENTS

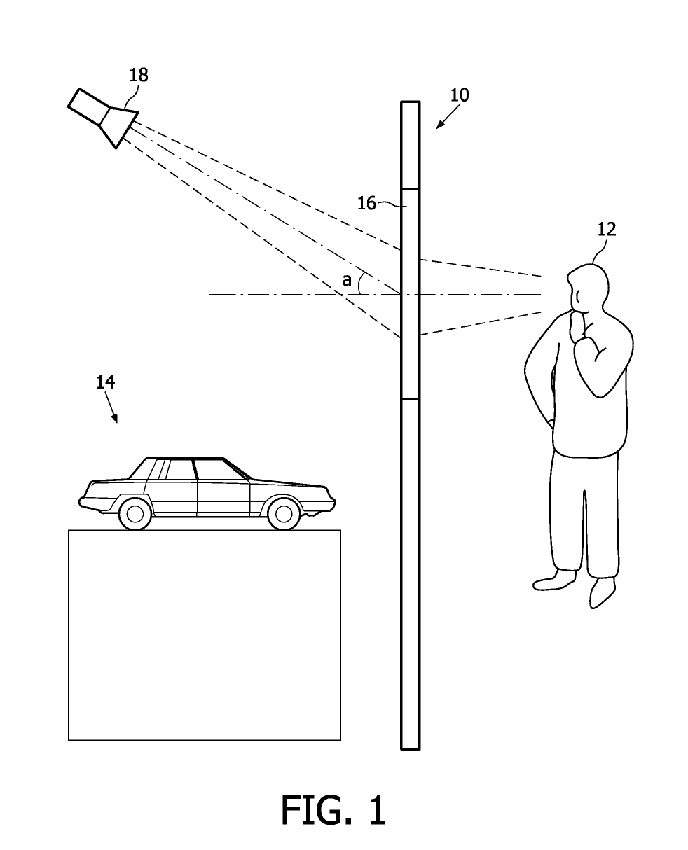

FIG. 1 illustrates an arrangement of the projection system according to the present invention. Herein, a shopping window 10 is located between an objecting person 12 and an object of interest 14 being placed in a show room behind the shopping window 10. A projection screen 16 is disposed in the shopping window 10. The projection screen 16 could be integrated in the shopping window 10 or mounted to an inside or outside surface of the shopping window 10. In addition, the projection screen 16 could be a separate screen being located behind the shopping window 10, wherein the projection screen 16 can be hung from a ceiling of the show room or mounted on a floor stand.

The projection screen 16 has a front side facing the objecting person 12 for providing the person 12 with information about the object of interest 14 or other information concerning general customer interests. Further, the projection screen 16 has a rear side, on which an image of a projector 18 is projected and then deflected to the person 12. The projector 18 is located in an upper portion of the show room behind the shopping window 10 above the projection screen 16 and projects the image at an inclined angle to the projection screen 16. Herein, the angle of incidence cc is preferably about 30° or more to enable a hidden placement of the projector 18. Alternatively, the projector 18 could be placed in a bottom region of the show room, wherein the projection screen 16 has to be modified to deflect the incoming light into a horizontally opposite direction.

The direction of the emitted light of the projection screen 16 is nearly parallel to the surface normal of the projection screen 16 and is preferably in a limited angular range between −10° and 10°.

The projection screen 16 of the present invention can be switched between a transparent mode and a refractive mode, wherein the detailed structure of this projection screen 16 and its manufacturing method will be explained in more detail in the following.

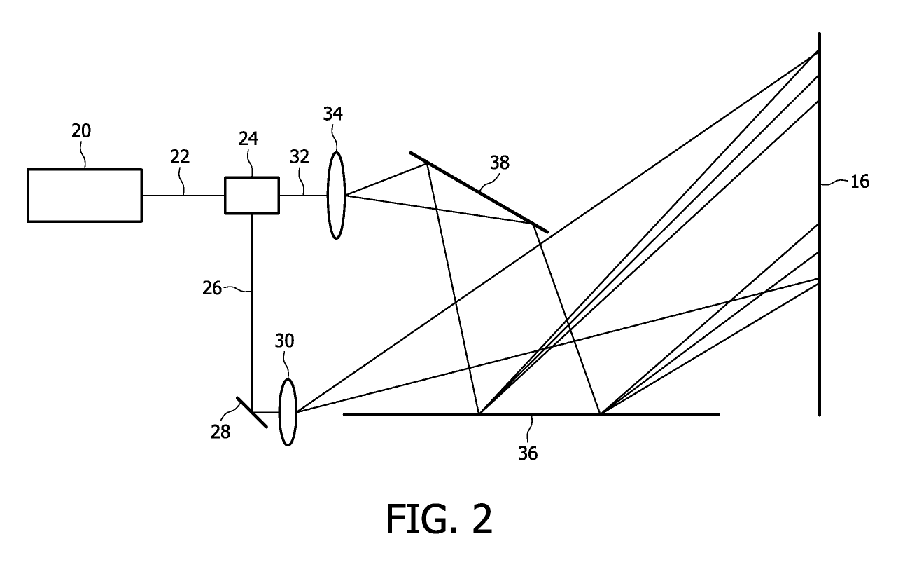

FIG. 2 shows a setup for manufacturing the projection screen 16 according to the present invention. Herein, an arrangement could be employed, which is also applicable for static holographic projection screens comprising a holographic film attached to a transparent or diffusive substrate.

The setup for making the projection screen 16 comprises a laser source 20 for emitting a laser beam 22, which is split into two parts by a beam splitter 24. The first branch 26 of the splitted laser beam 22 representing the reference beam is reflected by a mirror 28 to a first lens 30 for expanding the reference beam and illuminating the projection screen 16. The second branch 32 of the splitted laser beam 22 is diverged by a second lens 34, and reflected to a diffuser 36 by a mirror 38. The light scattered by the diffuser 36 is then hitting the projection screen 16. Together with the reference beam an interference pattern is formed representing a hologram of the diffuser 36 in the projection screen 16. The line perpendicular to the surface of the projection screen 16 is considered as the system's optical axis. In this setup the interference pattern recorded on the projection screen 16 has a form of concentric rings incident at the point where the optical axis intersects the surface of the projection screen 16. Hence, when the projection screen 16 is illuminated by a projector 18, the reflected beams from the projection screen 16 will converge to the axis for any wavelengths of the light of the projector 18. The use of a diffuser 36 is a common way in holography to enhance the visibility of a hologram. In this case, the use of the diffuser 36 is essential, since it provides the desired projection properties of the screen 16

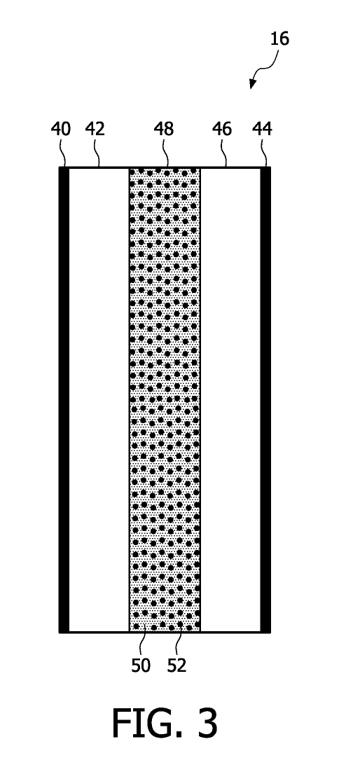

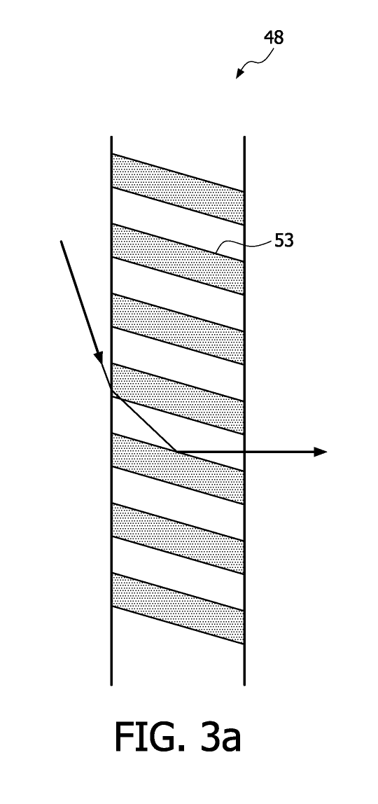

FIG. 3 shows a schematical structure of the projection screen 16 according to the present invention.

The projection screen 16 comprises a first transparent electrode 40 on a first transparent substrate 42 and a second transparent electrode 44 on a second transparent substrate 46, wherein a composition 48 of a liquid crystal material 50 and a compound material 52 is sandwiched between the first transparent substrate 42 and the second transparent substrate 46. It should be noted that the first transparent electrode 40 and the second transparent electrode 44 have to be not necessarily disposed on an outside surface of the first and second transparent substrates 42, 46. It is, however, also possible to arrange these electrodes next to the composition 48. Herein, additionally a planarization layer between the electrodes 40, 44 and the composition 48 could be provided (not shown in FIG. 3). Further, a rubbed intermediate layer (not shown in FIG. 3) could be provided facing the composition 48 of the liquid crystal material 50 and the compound material 52 to set an angular orientation of the liquid crystal material 50 with respect to the substrates 42, 46.

In the following, the manufacturing process of the composition 48 according to a first embodiment of the present invention will be described. As already discussed with regard to the setup for making the projection screen 16 in FIG. 2, an interference pattern with bright and dark regions is projected in a manufacturing process on the projection screen 16 and accordingly into a precursor mixture of the composition 48 of FIG. 3. Herein, as the precursor mixture, a homogeneous mixture of photosensitive prepolymer and non-reactive liquid crystal is exposed to the interference pattern generated by the setup of FIG. 2. In this process, polymerization of the polymer compound material 52 occurs more rapidly in the bright regions of the interference pattern than in the dark regions, which forces the non-reactive liquid crystal material 50 into the dark regions. This counterdiffusion process quickly creates a stratified compositional profile between liquid-crystal-rich and polymer-rich layers, which is ultimately locked in the photopolymerization process. Herein, the morphology of the formed polymer compound material 52 could be channel like (as shown in FIG. 3, for the sake of illustration only), or can have a polymer scaffolding that traverses the liquid-crystal-rich region. However, a more common situation is when the liquid crystal is totally encapsulated in droplets.

This so-called holographic polymer-dispersed liquid crystal (HPDLC) builds a switchable Bragg grating 53, which is illustrated in FIG. 3a. Herein, the Bragg grating 53 formed by the polymer compound material 52 could be covered or uncovered by switching the refractive index of the surrounding (or encapsulated) liquid crystal material 50 from equal to unequal to the refractive index of the compound material 52.

Thus, as shown in FIG. 3a, light from a inclined angle to the surface normal of the projection screen 16 is incident to the Bragg grating 53 of the composition 48 and deflected due to a reflection by the Bragg grating structure 53 formed by the compound material 52 and the liquid crystal material 50 (as shown in FIG. 3) into a direction being substantially parallel to the surface normal of the projection screen 16. A preferred period of the grating structure would be 1000 nm and a slant angle of this grating structure could be about 10° with respect to the surface normal of the projection screen 16 (as indicated by the lines of the Bragg grating structure 53 formed of the composition layer 48).

The HPDLC film exhibit excellent optical properties with a low scattering and absorption in the visible and near infrared, diffraction efficiencies comparable to those of photopolymer holographic media and a fast dynamic response time. However, the HPDLC layer is highly polarisation selective. The strong polarisation dependence is due to the highly aligned nature of the liquid crystal, which tends to align, on average, orthogonal to the holographic plane for most transmissive mode HPDLC materials. Therefore, p-polarized light is diffracted more effectively than s-polarized light. In fact, the refractive index of the liquid crystal material without electrical field is almost equal to the refractive index of the polymer for s-polarization, so there is little or no diffraction.

When no voltage is applied between the first and the second electrode 40, 44, the two kinds of layers of the composition 48 have a different refractive index, leading to a periodic structure of the HPDLC material associated with a diffraction of the incident light. In a transparent mode, the voltage between the first and second electrode 40, 44 is set such that the refractive indices of the liquid crystal material 50 and the compound material 52 are the same, leading to no or little diffraction in the composition 48. Thus, the projection screen 16 could be switched between a diffractive mode and a transparent mode.

In the following, further embodiments for a composition 48 of a liquid crystal material 50 and a compound material 52 will be discussed. A first alternative to the HPDLC material is the so-called polymer liquid-crystal polymer slices (POLICRYPS) material, which is comparable to the structure of the HPDLC material, however, the gratings of the alternating polymer and liquid crystal layer are purer than in the HPDLC material, since a droplet formation of the liquid crystal material is avoided.

For manufacturing such a material, a sample of photoinitiator-monomer-liquid-crystal mixture is heated to a temperature that is above the nematic-isotropic transition point of the liquid crystal component. This step prevents the appearance of a nematic phase during the curing process. After heating the sample, it is illuminated with a curing UV radiation having the interference pattern as described above. After that, the sample is cooled slowly below the isotropic-nematic transition point after the curing UV radiation has been switched off and the polymerization process has come to an end.

Another embodiment of the composition 48 is the so-called polymer liquid-crystal polymer hologram being electrically manageable (POLIPHEM), which has a comparable morphology with respect to the POLICRYPS material. These two embodiments are providing a non-droplet structure affecting the properties of the Bragg grating of the compound material 52 in many positive ways, such as scattering losses are strongly reduced, due to the absence of incoherent reflections, the switching voltage is much lower as the dimension of the liquid crystal domains is not given by the droplet size but by the grating spacing, higher refractive index modulations are achievable, and a sharper resolution of the grating fringes as well as a time response in the microsecond range can be achieved. This material works also only with polarised light, as described above with respect to the HPDLC material.

A further embodiment of the composition 48 of liquid crystal material 50 and compound material 52 is a photopolymerized mixture of monoacrylates, diacrylates and non-reactive liquid crystal material forming a liquid crystal gel. Herein, after polymerization, lightly cross-linked anisotropic polymer networks swollen by the non-reactive molecules are produced, wherein a liquid crystal polymer forms a rigid structure with liquid crystal in between. By use of a patterned radiation, regions with different threshold voltages for switching could be produced. Herein, the cross-linked network provides the system with a memory function and facilitates reversal to the initial orientation state after switching. Thus, patterns like Bragg gratings could be created in the gel, which become visible/unvisible by application of an electrical field. This gel is transparent at zero voltage, whereas upon applying a voltage, the liquid-crystal material can be oriented such that light is scattered.

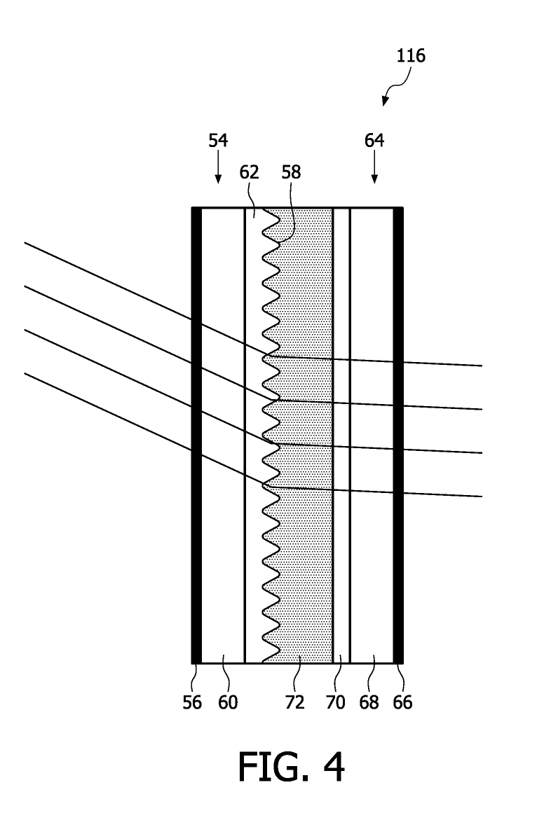

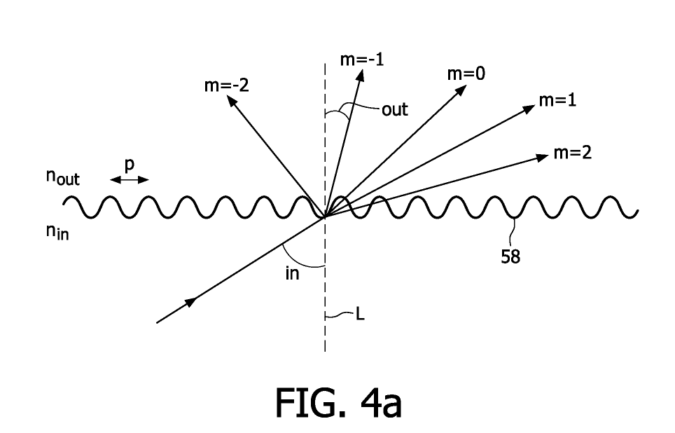

FIG. 4 shows another embodiment of a rear projection screen 116 according to the present invention. The projection screen 116 comprises a first transparent substrate 54, on which on one side a first transparent electrode 56 is disposed. On the other side of the first transparent substrate 54 a relief portion with a surface-relief grating 58 is located. The first transparent substrate 54 is composed of a support layer 60 made of PMMA (polymethyl methacrylate) and a relief layer 62 made of polycarbonate. The projection screen 116 further comprises a second transparent substrate 64 having a second transparent electrode 66, a support layer 68 made of glass or PMMA and a rubbed polyimid layer 70, stacked in this order.

Between the first and second transparent substrates 54 and 64, a liquid crystal layer 72 is located facing on its one side next to the first transparent substrate 54 the relief portion or relief layer 62 and filling the surface-relief grating 58. On its other side next to the second transparent substrate 64, the liquid crystal layer 72 faces the rubbed polyimid layer 70, wherein the rubbed polyimid layer 70 is provided to set an orientation angle of the liquid crystal material sandwiched between the first and second transparent substrates 54, 64.

The first and second electrodes 56 and 66 could be arranged at portions different to the arrangement of the stacked layer as shown in FIG. 4, for example the first transparent electrode 56 could be also disposed between the support layer 60 of the first transparent substrate 54 and the relief layer 62, and the second transparent electrode 66 could be disposed between the support layer 68 and the rubbed polyimid layer 70.

The refractive index of the liquid crystal material could be switched to be equal or unequal of the adjoining polycarbonate layer, thus the surface-relief grating could be hidden/unhidden due to the switchable difference between the refractive indices of the liquid crystal material and the relief layer at the transition between these layers.

The period of the two-dimensional grating is about 1000 nm and the modulation depth of this grating is about 200 nm. Again, the grating is preferentially made by a set-up like shown in FIG. 2, where the use of a diffuser provides the desired amount of spread in angle and wavelength.

It is further possible to manufacture the surface-relief grating structure by embossing, wherein a first grating could be formed using the setup of FIG. 2 for generating an interference pattern, which is then transferred to the embossing master by means of electroforming into nickel. This can be used as embossing tools for precision micro replication processes, such as injection moulding, hot embossing or continuous film replication.

The diffraction mechanism of the projection screen 116 is different from the diffraction as described above in view of the volume Bragg grating of the projection screen 16. For illustrating this diffraction mechanism of the projection screen 116, a schematic view of diffraction at a well known diffraction grating is shown in FIG. 4a.

The light being incident at the surface-relief grating with an angle θᵢₙ to the surface normal L is diffracted at the surface-relief grating 58 having a grating period p, wherein the grating equation is mλ=p (nₒᵤₜ sin θₒᵤₜ−nᵢₙ sin θᵢₙ), with nᵢₙ being the diffractive index of the relief portion of the first transparent substrate 54 or of the relief layer 62, nₒᵤₜ being the diffractive index of the liquid crystal layer 72, and m representing the diffraction order. In the embodiment of the present invention, it is preferred to choose the angle of exit θₒᵤₜ to be the first order diffraction of the incoming light at m=−1. Thus, a high luminance of diffracted light could also be achieved by way of a surface-relief grating 58. As can be seen from the above grating equation, the screen is easily switchable by making the diffractive indices nₒᵤₜ and nᵢₙ equal or unequal, which could be performed by applying an electrical field to the liquid crystal layer 72 generated by the first and second electrodes 56 and 66.

1. A rear projection system comprising
a projector (18), and
a projection screen (16) being switchable between a transparent mode and a diffractive mode,
wherein the projector (18) is located with respect to the projection screen (16) such that light from the projector (18) is incident at an inclined angle at the rear side of the projection screen (16), the projection screen (16) is adapted to deflect in its diffractive mode the incident light into a limited angular range with respect to the front surface normal of the projection screen (16).

2. A rear projection system as claimed in claim 1, wherein the projection screen (16) is used as a shopping window.

3. A rear projection system as claimed in claim 1, wherein the angle of incidence between the incident light and the rear surface normal of the projection screen (16) is bigger than 30°.

4. A rear projection system as claimed in claim 1, wherein the limited angular range extends from −10° to 10° in the vertical direction.

5. A rear projection system as claimed in claim 1, wherein the light from the projector (18) is polarised.

6. A rear projection system as claimed in claim 1, wherein the projection screen (16) comprises:
a first transparent substrate (42) with a first transparent electrode (40),
a composition (48) of a liquid crystal material (50) and a compound material (52),
a second transparent substrate (46) with a second transparent electrode (44), wherein the refractive index of the liquid crystal material (50) being disposed between the first and second substrate (42, 46) is switchable by means of electrical field generated by the first and second electrode (40, 44) to be substantially equal or different to the refractive index of the compound material (52).

7. A rear projection system as claimed in claim 6, wherein the compound material (52) is a polymer.

8. A rear projection system as claimed in claim 6, wherein the composition of the liquid crystal material (50) and the compound material (52) is adapted to form a switchable Bragg grating.

9. A rear projection system as claimed in claim 8, wherein the composition of the liquid crystal material (50) and the compound material (52) is a holographic polymer-dispersed liquid crystal (HPDLC) material.

10. A rear projection system as claimed in claim 8, wherein the composition of the liquid crystal material (50) and the compound material (52) is a polymer liquid-crystal polymer slices (POLICRIPS) material or an electrically manageable polymer liquid-crystal polymer hologram (POLIPHEM) material.

11. A rear projection system as claimed in claim 8, wherein the composition of the liquid crystal material (50) and the compound material (52) is a photopolymerized mixture of monoacrylates, diacrylates and non-reactive liquid crystal material forming a liquid crystal gel.

12. A rear projection screen (116) being switchable between a transparent mode and a diffractive mode, the projection screen (116) comprises:
a first transparent substrate (54) comprising a first transparent electrode (56) and a relief portion with a surface-relief grating (58),
a liquid crystal material (72) located next to the relief portion of the first transparent substrate (54) and filling the surface-relief grating (58),
a second transparent substrate (64) with a second transparent electrode (66), wherein the refractive index of the liquid crystal material (72) could be changed by means of electrical field of the first and second electrode (56, 66) to be substantially equal or different from the refractive index of the relief portion of the first transparent substrate (54).

13. A rear projection screen (116) as claimed in claim 12, wherein the first transparent substrate (54) comprises a support layer (60) made of PMMA and a relief layer (62) made of polycarbonate facing the liquid crystal layer (72).

14. A rear projection screen (116) as claimed in claim 12, wherein the second substrate (64) comprises a support layer (68) made of glass and a rubbed polyimid layer (70) facing the liquid crystal layer (72).

15. A rear projection screen (116) as claimed in one of the claim 12, wherein the surface-relief grating (58) has a grating period of about 1000 nm and a modulation depth in the range of about 100-300 nm.

16. A method for manufacturing a rear projection screen (116) as claimed in claim 12, comprising the steps of:
providing a first transparent substrate (54) comprising a first transparent electrode (56) and a transparent surface portion being prepared for an embossing process,
embossing the transparent surface portion to form a relief portion in the first transparent substrate (54) having a surface-relief grating (58),
depositing a liquid crystal material (72) on the relief portion of the first transparent substrate (54), filling the surface-relief grating (58),
providing a second transparent substrate (64) with a second transparent electrode (66), and
assembling the first transparent substrate (54) and the second transparent substrate (64).

17. The method as claimed in claim 16, wherein the embossing is performed by injection moulding, hot embossing or by continuous film replication.
